(19) United States
(12) Patent Application Publication
(10) Pub. No.: US 2026/0161449 A1
(43) Pub. Date: Jun. 11, 2026

(54) VIRTUAL MACHINE ARCHITECTURE FOR ACCESSING A SECURE ELEMENT, AND CORRESPONDING METHOD FOR ACCESSING A SECURE ELEMENT

(71) Applicant: STMicroelectronics International N.V., Geneva (CH)

(72) Inventors: Marco ALFARANO, Pozzuoli (IT); Antimo DE BIASE, Monte di Procida (IT); Simone VALLIFUOCO, Napoli (IT)

(73) Assignee: STMicroelectronics International N.V., Geneva (CH)

(21) Appl. No.: 19/413,523

(22) Filed: Dec. 9, 2025

(30) Foreign Application Priority Data
Dec. 11, 2024 (IT) 102024000028116

(51) Int. Cl. G06F 9/48; G06F 9/455

(52) U.S. Cl. CPC G06F 9/4881; G06F 9/45558; G06F 2009/45583

(57) ABSTRACT

A hypervisor of a virtual machine architecture includes a scheduler module configured to manage execution of commands. The scheduler module operates to: measure an execution time of each command sent to an application in a Secure Element; update a scheduler data structure that stores for each different command, an estimated execution time value (estimated on the basis of measured execution times for the command); store received commands in a queue structure; calculate a remaining time before time out for each command in the queue as a function of a corresponding estimated execution time value obtained from the data structure and a request time out value; execute first the command having the minimum remaining time before time out by sending the command to a Logical Secure Element of the respective application.

### PRIORITY CLAIM

This application claims the priority benefit of Italian Application for Patent No. 102024000028116 filed on Dec. 11, 2024, the content of which is hereby incorporated by reference in its entirety to the maximum extent allowable by law.

### TECHNICAL FIELD

The description relates to a virtual machine architecture comprising a plurality of guest virtual machines managed by a hypervisor running on a host computer, on which respective instances of a guest operating system, in particular an Android operating system, are executed, said architecture comprising at least a Secure Element accessible by said plurality of virtual machines, said hypervisor being configured to receive a command from given guest operating system among said guest operating systems and to send said command to a corresponding application in said Secure Element and to send a response to said command from said application in said Secure Element to the given guest operating system.

One or more embodiments can be applied to Secure Element in integrated circuit cards such as, for instance, Universal Integrated Circuit Cards (UICCs) or embedded UICCs (eUICCs).

### BACKGROUND

In technical fields such as the automotive field, the Hypervisor architecture is requested to support multiple instances of Linux (or Linux-Android or Android or QNX) executing in parallel in a virtual machine architecture. Such instances may be instances of Android operating system and/or Linux operating system and/or Linux-Android, or analogous operating system.

A virtual machine architecture may be defined as an architecture comprising a set of virtual machines hosted, or managed, by a so-called hypervisor (i.e., a virtual machine monitor) on which respective instances of an operating system are executed, may be used. In this environment, if at least a Secure Element (i.e., a tamper-resistant platform (typically a one chip secure microcontroller) capable of securely hosting applications and their confidential and cryptographic data, in particular in accordance with the rules and security requirements set forth by a set of well-identified trusted authorities) is comprised in the architecture, a same Secure Element shall be accessible, for instance in terms of crypto services and key store services, by different virtual machines. A Universal Integrated Circuit Card (UICC) may represent a Secure Element, also as an (Embedded UICC (eUICC) or Integrated Circuit Card (iUICC).

To this regard in FIG. 1 a virtual machine architecture 10 is shown schematically by way of example, which comprises a host, or host computer, 11 (e.g., a processing unit, comprising for instance a CPU and volatile and non-volatile memory). The host 11 hosts a virtual machine monitor 12, also called hypervisor, as mentioned. The term ‘host computer’ here refers to a computing unit (e.g., a processing unit) and it is thus not limited to a desktop computer, laptop computer or computer on a rack, but may include a computer board, a terminal, either mobile or not, or any module with a processing unit.

The hypervisor 12, in a manner known per se, by the virtualization process is able to create a set of guest virtual machines (VM) each running an instance, indicated with 13₁, . . . , 13₅ in FIG. 1, of an operating system, for instance Android. A set refers here to a group of one or more elements (e.g., one or more virtual machines).

A Secure Element 14 is shown in FIG. 1, associated to the host 11 of the hypervisor 12, which can be represented for instance by an UICC.

Such virtual machine architecture 10 comprising a set of virtual machines may refer to a terminal, as host (e.g., a user terminal), which is interfaced to an integrated circuit card (e.g., a UICC as mentioned), by a terminal-card, or terminal-UICC interface, the UICC may represent such Secure Element 14. As mentioned, alternately, eUICC or iUICC, can embody the Secure Element 14, which also may be embodied by an embedded Secure Element (eSE) or an integrated Secure Element (iSE).

The hypervisor 12 used to host multiple virtual machines, may comprise, in the automotive field, e.g., one virtual machine hosting an instance 13ᵢ of the operating system for each display (e.g., dashboard/infotainment). Where i as indicated is the index of the guest operating system, i.e., in FIG. 1 goes from 1 to 5.

The hypervisor 12 may run for instance on a System On Chip (SoC) which represents the terminal (i.e., the host 11) interfaced to a secure element or card 14. This, in particular, in an automotive embodiment, although in general the terminal corresponding to the host 11 can be another device with a processing unit or microcontroller.

In particular, a virtual machine architecture as just described represents a multi-application capable terminal, i.e., a terminal that can support more than one first level application with possibly separate user verification requirements for each application. The applications seen by the terminal are first level applications (e.g., SIM, USIM). In the context of Secure Elements, e.g., integrated circuit cards or Secure Elements, Logical Secure Element (LSE) are secure element functionalities, applications and files grouped together to act like a secure element (e.g., UICC) when multiple Logical Secure Element interfaces are supported (see for instance the specification ETSI TS 102 221 or ETSI TS 102 241). A Logical Secure element Interface (LSI) is instead a logical connection between an endpoint in the terminal, e.g., SoC, running the hypervisor, and one Logical Secure Element or LSE. An application is associated to a Logical Secure Element in that it is grouped together in a group of secure element functionalities, applications and files grouped together to act like a secure element. An application or applet is associated to an LSE also means that a specific LSE is defined as the application context. Thus, for instance within the environment of the specification ETSI TS 102 221, it is possible to operate with Multiple Instances and Multiselectable Applets. It is, in particular, possible to create multiple instances of an Applet with different AIDs (Application Identifiers). As mentioned, Multiselectable Applets are Applets having the capability of being selected on multiple logical channels at the same time.

The common way a Hypervisor uses to manage a shared resource is a Shared Device in the Hypervisor, the access to resources by Guest OS 13 being not direct: requests are managed by the Hypervisor 12 and are serviced as they are. If two or more Guests 13 try to access a device at same time, that is prevented by using a queue-based approach: one request at time, which may also increase application runtime.

Different scheduling strategies for guest operating systems requests may be applied, e.g., First Come First Served (FCFS), Highest Priority Guest, Shortest Job Next (SJN), Earliest Deadline First (EDF), however they do not account for all the relevant time factors and priority at the same time.

There is a need in the art to contribute in providing solutions to improve taking in account all the relevant time factors and priority at the same time in the scheduling strategy in the virtualization architecture.

### SUMMARY

One or more embodiments concern a virtual machine architecture.

One or more embodiments concern a corresponding method for operating such architecture.

Solutions as described herein include a virtual machine architecture comprising a plurality of guest virtual machines. A virtual machine architecture comprises a plurality of guest virtual machines managed by a hypervisor running on a host, on which respective instances of a guest operating system, are executed, said architecture being configured to access at least a Secure Element, comprising a plurality of Logical Secure Elements associated to corresponding instances of a guest operating system, by said plurality of virtual machines. Said hypervisor is configured to receive one or more commands, in particular a command APDU, from at least an entity configured to send commands to a Logical Secure Element in said Secure Element to be used by an application associated to said Logical Secure Element, and to send said command to said Logical Secure Element in said Secure Element to be used by the application associated to said Logical Secure Element in said Secure Element.

Said hypervisor comprises a scheduler module configured to manage execution of said commands, in particular APDUs, coming from said at least an entity, said scheduler module being configured to: measure an execution time of each command sent to said application in said Secure Element; update a scheduler data structure, in particular a table, storing for each different command, an estimated execution time value, estimated on the basis of said measured execution times on a plurality of executions of said command.

Said scheduler module is configured to: store commands received from said at least an entity in a queue structure; calculate a remaining time before time out for each command in said queue as a function of a corresponding estimated execution time value obtained from said data structure and a request time out value corresponding to said at least an entity; and execute first the command APDU with the minimum remaining time before time out sending said command to the Logical Secure Element of the respective application.

In variant embodiments, said function is a difference between a corresponding estimated execution time value obtained from said data structure and a request time out value corresponding to said least an entity.

In variant embodiments, said estimate is the average of said measured execution time calculated over a number of executions of said command.

In variant embodiments, said update comprises also storing in said data structure table said number of executions and parameters associated to the command.

In variant embodiments, said at least an entity comprises a given guest operating system among said guest operating systems.

In variant embodiments, in said scheduler comprises a settable execution time windows size setting the size of a mobile window, which takes in account only a number of last measurements of the execution time for each command.

In variant embodiments, said request timeout is a fixed timeout known a priori or a timeout calculated during a setup phase of the scheduler.

In variant embodiments, said structure data, in particular table, is initialized with a known set of commands and an estimate of their execution time.

In variant embodiments, said scheduling module is configured to additionally perform a prioritization scheme, assigning different priorities to different of said entities, in particular guest operating systems.

In variant embodiments, said hypervisor comprises a driver of the Secure Element associated to said guest operating system through a respective virtual device and the virtual device is configured to pass commands, and responses between the said guest operating system and the Secure Element through said scheduler.

In variant embodiments, said scheduler is configured to allocate different tables for different applications.

In variant embodiments, said architecture is configured to access a set of Logical Secure Elements in said Secure Element, which are accessible from said guest operating systems, in particular Android operating systems.

Solutions as described herein refer also to a method for operating a virtual machine architecture comprising a plurality of guest virtual machines managed by a hypervisor running on a host, on which respective instances of a guest operating system, are executed. Said architecture accesses at least a Secure Element, comprising a plurality of Logical Secure Elements associated to corresponding instances of a guest operating system, by said plurality of virtual machines by: receiving at the hypervisor one or more commands, in particular a command APDU, from at least an entity sending commands to a Logical Secure Element in said Secure Element to be used by an application associated to said Logical Secure Element, and sending said command to said Logical Secure Element in said Secure Element to be used by the application associated to said Logical Secure Element in said Secure Element. The method includes: managing at a scheduler module in said hypervisor execution of the commands, in particular APDUs, coming from said at least an entity, by: measuring an execution time of each command sent to said application in said Secure Element; updating an estimated execution time value, estimated on the basis of said measured execution times on a plurality of executions of said command; storing commands received from said at least an entity in a queue structure, calculating a remaining time before time out for each command in said queue as a function of a corresponding estimated execution time value obtained from said data structure and a request time out value corresponding to said least an entity; and executing first the command APDU with the minimum remaining time before time out sending said command to the Logical Secure Element of the respective associated application.

In variant embodiments, said function is a difference between a corresponding estimated execution time value obtained from said data structure and a request time out value corresponding to said least an entity and said estimate is the average of said measured execution time calculated over a number of executions of said command.

### BRIEF DESCRIPTION OF THE DRAWINGS

One or more embodiments will now be described, by way of example only, with reference to the annexed figures, wherein:

FIG. 1 shows schematically a virtual machine architecture;

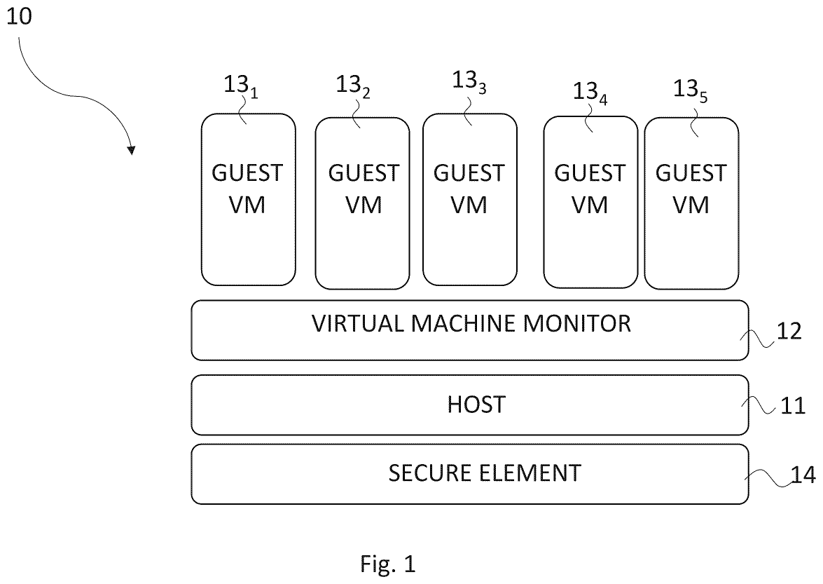

FIG. 2 shows schematically a virtual machine architecture detailing the operating system, the hypervisor and the host;

FIG. 3 shows a portion of the virtual machine architecture according to the solution here described pertaining the host and the Secure Element; and

FIG. 4 shows a flow diagram of a scheduling procedure implemented by the virtual machine architecture according to the solution here described.

### DETAILED DESCRIPTION

Corresponding numerals and symbols in the different figures generally refer to corresponding parts unless otherwise indicated.

The figures are drawn to clearly illustrate the relevant aspects of the embodiments and are not necessarily drawn to scale.

The edges of features drawn in the figures do not necessarily indicate the termination of the extent of the feature.

In the ensuing description one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment.

Moreover, particular configurations, structures, or characteristics may be combined in any adequate way in one or more embodiments.

The headings/references used herein are provided merely for convenience and hence do not define the extent of protection or the scope of the embodiments.

For simplicity and ease of explanation, throughout this description, and unless the context indicates otherwise, like parts or elements are indicated in the various figures with like reference signs, and a corresponding description will not be repeated for each and every figure.

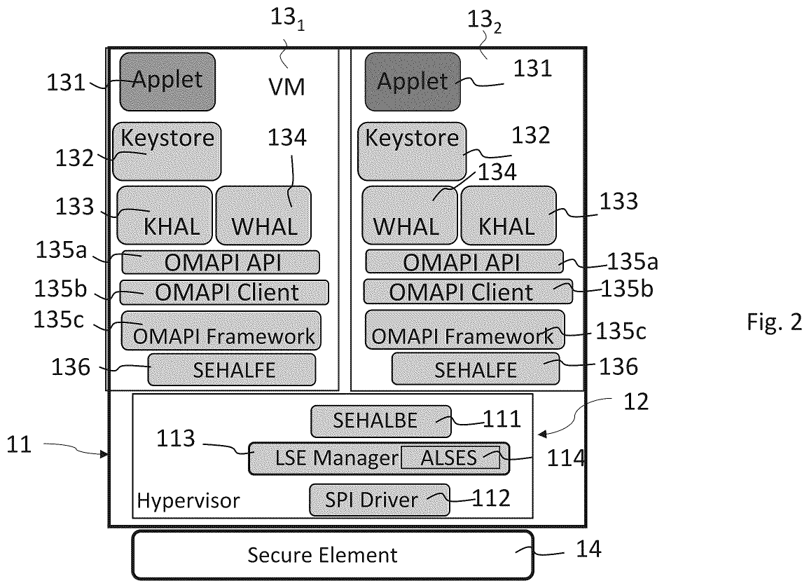

FIG. 2 shows a virtual machine architecture 10 according to the solution here described. In the example of FIG. 2, the hypervisor 12 which runs in the host 11 manages two virtual machines respectively running a first Android operating system 13₁ and a second operating system 13₂.

The architecture 10 is configured to access a set of Logical Secure Elements in the Secure Element 14, which are accessible from such guest operating systems 13ᵢ, in particular Android operating systems.

Each of these operating systems 13₁ and 13₂ comprises respective applets 131 and also a keystore 132, in particular an Android keystore, which stores cryptographic keys in a container to make them more difficult to extract from the device, then a Keymint Hardware Abstraction Layer (KHAL) 133, Keymint providing cryptographic services in a hardware-isolated environment and a Weaver Hardware Abstraction Layer (WHAL) 134, which provides a fixed number of slots for storing user data. Thus, the operating systems 13₁ and 13₂ comprise a number of modules for cryptographic keys and authorizations. Also, the operating systems 13₁ and 13₂ comprise a series of Open Mobile API (OMAPI) module comprising the OMAPI API (Application Programming Interface) 135a, an Internal OMAPI Client 135b, an OMAPI framework 135c.

The operating systems 13₁ and 13₂ then comprise a Secure Element Hardware Abstraction Layer Front End (SEHALFE) 136, which, as explained in the following, represents the front end of a virtual device vdev, e.g., such as the VirtIO vdev.

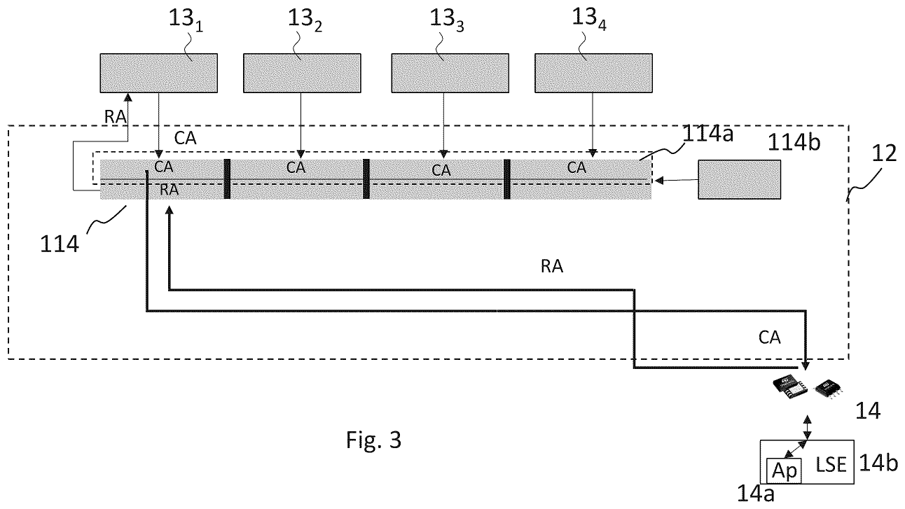

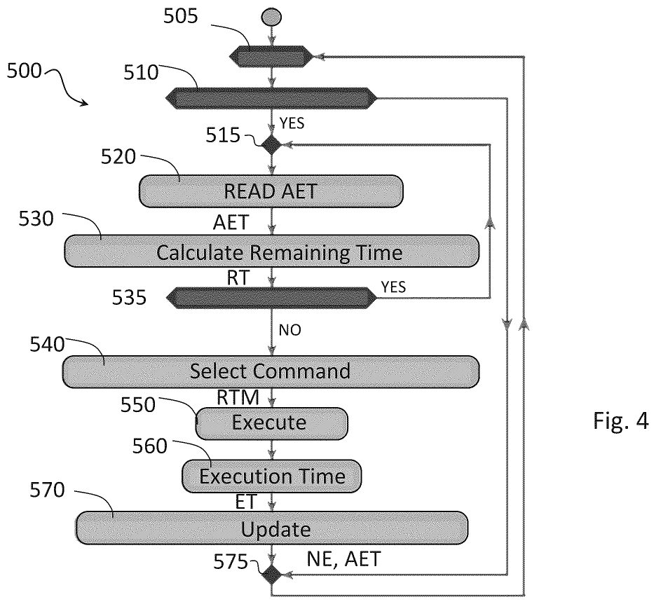

The host 11 in its turn comprises a Secure Element Hardware Abstraction Layer Back End (SEHALBE) 111 to communicate with the operating system Secure Element Hardware Abstraction Layer Front End 136, i.e., implementing the back end of the virtual device vdev, when for instance the guest operating system 13₁ or 13₂ request to access the Secure Element 14 (as it will be explained in the following, in FIGS. 3 and 4, for instance with reference to request or command CA).

Under this view the host 11 also comprises a Secure Element SPI (Serial Parallel Interface) Driver 112 to drive the interface with the Secure Element 14 for accessing the Secure Element.

More in detail, in FIG. 2 shows that in the virtual machine architecture here described the host 11, which includes the Secure Element Hardware Abstraction Layer Front End 111 and the Secure Element SPI (Serial Parallel Interface) Driver 112 to drive the interface with the Secure Element 14 for accessing the Secure Element, includes also a Logical Secure Element (LSE) Manager module 113 which is configured to manage the Logical Secure Elements in such Secure Element 14, according for instance to the TS ETSI specification 102.221. Such Logical Secure Element Manager module 113 includes an Adaptive Logical Secure Element Scheduler (ALSES) 114. An application 14a is shown in FIG. 3 which is stored in or associated to a Logical Secure Element 14b, which in particular corresponds to one of the guest operating systems 13ᵢ. Other Logical Secure Elements may thus be present in the Secure Element 14, but are not shown for simplicity.

Thus, in FIG. 3 it is shown instead a portion of the architecture detailing the interaction between the guest operating systems 13ᵢ, the hypervisor 12, which runs in the host 11 shown in FIG. 2, and the Secure Element 14. Thus, in FIG. 3 it can be seen how each guest OS, e.g., 13₁, . . . , 13₄ in FIG. 3, may send a respective command, or a request, for an applet, specifically an APDU (Application Data Unit) command CA to the Adaptive Logical Secure Element Scheduler 114 comprised in the hypervisor 12, which puts such APDU command CA from the different guest OS, e.g., 13₁, . . . , 13₄, in a queue 114a. In particular, the command CA is sent to a virtual device, not shown in the figure of the hypervisor 12. The virtual device corresponds as front end to the Secure Element Hardware Abstraction Layer Front End 136 of FIG. 2 cooperating with the back end 111 in the hypervisor 12. A virtual device is a device existing in the virtualized environments, which can emulate a physical device, or it can provide functionality like that provided by a physical device without emulating any specific physical device. To use a virtual device vdev, the guest OS 13₁ may require a driver, as indicated below, just as it would require a driver to use a physical device in a non-virtualized environment. The virtual device of the hypervisor 12 operates as an intermediary that both responds directly to the guest OS 13₁ and passes requests, i.e., command CA, and responses, i.e., responses RA, between the guest OS 13₁ and a physical device, in this case the Secure Element 14.

The Adaptive Logical Secure Element Scheduler 114 is configured then to send the commands CA stored in the queue 114a, i.e., the command APDU, to the low level driver which then sends the command CA to the Secure Element, in particular to the Logical Secure Element (LSE), e.g., 14b, to which the corresponding applet (Ap) 14a (i.e., the applet which then uses the command APDU CA, e.g., executes the command APDU CA) is associated, in particular by a low level driver. The Secure Element 14, in turn replies with a corresponding response RA, e.g., a Response APDU to the Adaptive Logical Secure Element Scheduler 114.

The Adaptive Logical scheduler module 114 is configured to operate on the basis of a data structure represented by an Adaptive Logical Secure Element table 114b included or associated in the Adaptive Logical scheduler module 114 which stores for each APDU command CA, i.e., each different APDU command CA, in particular, identified by a corresponding APDU instruction byte or instruction code INS, APDU parameters P1, P2, for the command, e.g., offset into file at which to write the data, a field to register to number NE of execution of that command CA on which an estimate of the command execution time AET, in particular an average command execution time AET is estimated, such average execution time AET of the specific command APDU.

The Adaptive Logical scheduler module 114 is configured to manage the queue 114a of APDU commands CA obtaining from the Adaptive Logical Secure Element table 114b the corresponding average execution time AET and calculating on the basis of the respective at least an entity, e.g., 13ᵢ, request timeouts, which command CA, in particular APDU, in such queue 114a has a minimum estimated remaining time RTM before time out T_{OUT}, sending for execution first the APDU CA with the minimum estimated time RTM before time out in the queue 114a. A request timeout is the time interval allocated to execute a request, e.g., a command CA, by the entity, e.g., the guest operating system entity 13ᵢ. On expiring of the timeout, the entity takes an action, e.g., cancel the request and/or send a new request.

Thus, the Adaptive Logical scheduler module 114 operates substantially as a scheduler associated to a dispatcher, which is a module included in the Logical Secure Element Manager module 113 which sends, again through the low level driver in particular, the APDU, i.e., commands CA, from the various guests to the secure element 14 and vice versa, in particular again through the low level driver dynamically adjusting to various factors including the timeout T_{OUTi} of the guest OS 13ᵢ and request execution times ET of the APDU command CA (which average value AET is updated during operation).

Besides the scheduling performed by the Adaptive Logical scheduler module 114, the Logical Secure Element Manager module 113 may, upon a guest OS, e.g., 13₁, request, send, performing an LSE switch, a command, or a request, for an applet, specifically an APDU (Application Data Unit) command CA to such scheduler 114, e.g., comprised in the hypervisor 12. In particular, the command CA is sent to the Driver 112.

The scheduler 114 module is thus configured to perform a dispatcher function to forward commands CA, in particular APDUs, sent from the virtual machine, i.e., the guest OS, e.g., 13₁ and to the driver module or to other modules, such as an interpreter, and thus may send the command CA to a driver module, not shown, which may in the hypervisor 12, outside the scheduler 114, which is configured to send the command CA, i.e., the command APDU, to the corresponding applet 14a in the Secure Element 14, which in turn replies with a corresponding response RA, also a Response APDU, in particular to the driver which sends the response RA to the dispatcher associated to the scheduler 114, which in turn sends the response RA to the guest operating system 13₁.

The Adaptive Logical scheduler module 114 is configured to dynamically adjust the scheduling of requests based on one or more of the following factors:
Guest TimeOut T_{OUTi}: the Adaptive Logical Secure Element Scheduler 114 is configured to handle fixed timeouts T_{OUTi} known a priori or calculate unknown timeouts T_{OUTi} during a setup phase;
Execution Window Size EWS: is the size of a mobile window, which takes in account only a number of last, i.e., most recent, measurements of the execution time ET for each command CA equaling the size, i.e., width of the windows EWS. Thus, the number of execution NE is updated but can reach only the limit of size of the Execution Window Size EWS if the Execution Window Size EWS is activated. Its width can be arranged with a width EWS of a number of execution NE lower to emphasize recent executions or to be bigger to be more robust against outliers;
Initialization of Adaptive Logical Secure Element table 114b: the Adaptive Logical Secure Element table 114b can be initialized, e.g., before operation, with a known set of APDU commands CA and an estimate of their execution time AET. Thus, the Adaptive Logical Secure Element table 114b can be persistent or re-initialized at system start and may include additional fields like AID (Application ID) if they affect execution time; and
Scheduling Algorithm: the scheduling method, besides the minimum remaining time RTM may also consider a priority associated to each guest operating system as an additional parameter, in particular where timeout expiration is taken into account for specific scenarios. Specifically, therefore the scheduler first evaluates the priority and then as second criterion the minimum remaining time RTM.

It is underlined that while in the exemplary embodiments is shown only an Adaptive Logical Secure Element table 114b, said scheduler 114 may be configured to allocate different tables 114b for different applications or applets.

The Adaptive Logical scheduler module 114 may be a software module integrated into the Hypervisor 12 firmware. This approach is different with respect to known solutions and provides a more comprehensive approach to the scheduling problem.

The Adaptive Logical scheduler module 114 is configured to calculate a minimum estimated time RTM, in particular a minimum estimated remaining time RTM, which is the minimum value among the values of remaining times RT for each command CA in the queue 114a, calculated as the difference with respect to the corresponding request timeout T_{OUTi}, thus as:

$$RTM = Min ( {T}_{OUTi} - AET ) \qquad ( 1 )$$

The request timeout T_{OUTi} depends on which guest OS 13ᵢ sends the command CA.

The Adaptive Logical Secure Element table 114b is represented in the following Table:

| | | | | AET |
|---|---|---|---|---|
| INS | P1 | P2 | NE | (ms) |
| A4 | 04 | 00 | 10000 | 15 |
| 21 | 60 | 00 | 1000 | 200 |
| . . . | . . . | . . . | . . . | . . . |

The Table comprises in a first column the APDU instruction byte INS, i.e., the code identifying the specific APDU command CA being received at the scheduler 114. Each row of table 114b corresponds thus to a record corresponding to a different APDU command CA. In a second and third column are the value of the APDU parameters P1, P2, for the command, e.g., offset into file at which to write the data. INS, P1 and P2 for instance are those of the corresponding codes described in the ETSI TS 102 221 for the command CA syntax.

Then in the fourth column is the number of execution NE, i.e., the number of occurrences, i.e., measured execution times ET, on which the average execution time AET is calculated, which, as said, can be adjusted with the size of the window EWS.

Finally, in the fifth column is the average execution time AET calculated over the number of execution NE. The Adaptive Logical scheduler module 114 itself may be configured to measure an execution time ET of a command CA by setting a timer or a counter calculating the time elapsed between sending to the applet 14a the command CA and receiving the reply RA. At each command CA received and sent to the applet 14 for execution, the Adaptive Logical scheduler module 114 may obtain the measured execution time ET and use that value to update the number of executions NE and the average execution time AET in the table 114b.

Each row of the Adaptive Logical Secure Element table 114b represents a different command CA, based on INS, P1, P2 values of the command.

FIG. 4 shows a flow diagram of the operations performed by the Adaptive Logical scheduler module 114 in a scheduling procedure 500. Basically, when a command APDU CA is present in a queue 114a, an average execution time AET is read from the Adaptive Logical Secure Element table 114b, estimating the corresponding remaining time RT. This is done for all the commands CA in the queue 114a. Then the command CA with the minimum estimated remaining time RTM is selected for execution, calculating its actual execution time ET to update the number of execution and average time value for that APDU CA in the Adaptive Logical Secure Element table 114b.

After the start, the procedure enters a loop node 505 and a return node 575 at the end of procedure 500 points, thus repeating continuously the procedure 500.

Then in a step 510 it is checked if there is any pending command CA in the queue 114.

In the negative, control passed to end node 575 which returns to loop node 505 to repeat the procedure 500.

In the affirmative, then in step 520 the average execution time AET is read from the Adaptive Logical Secure Element table 114b corresponding to the command CA in the queue 114, which may be the first in the queue 114s.

Then, in step 530, the estimated remaining time is calculated as T_{OUTi}−AET, i.e., the difference of the timeout for the specific entity, in particular guest OS, issuing the command CA, and the average execution time AET associated to that command CA in table 114.

Then, in step 535, it is checked if the queue 114a contains further commands CA to estimate.

In the affirmative, control goes back to a control node 515 before step 520, repeating steps 520 and 530.

In the negative, then in step 540 the command CA in the queue 114a with the minimum estimated remaining time RTM is selected for execution, as per the equation (1) above.

Then, in step 550, the selected APDU CA is executed, i.e., sent to the application 14a and there executed.

In a step 560, the execution time ET of that specific command CA is calculated or measured, for instance on the basis of the time of sending the command CA and the time of receival of the response RA from the application 14a.

Finally, in step 570 the number of executions for that command CA and average execution time AET in the Adaptive Logical Secure Element table 114b is updated.

Then, the return node 575 is reached which returns control to the initial loop node 505.

Thus, in summary, the solution here described refers to a virtual machine architecture, e.g., 10, comprising a plurality of guest virtual machines managed by a hypervisor, e.g., 12, running on a host, e.g., 11, on which respective instances of a guest operating system, e.g., 13ᵢ, are executed, such architecture being configured to access at least a Secure Element, in the example indicated with 14, comprising a plurality of Logical Secure Elements associated to corresponding instances of a guest operating system, e.g., 13ᵢ, by such plurality of virtual machines, e.g., 13ᵢ, such hypervisor, e.g., 12, being configured to receive one or more commands, indicated with CA in the example, in particular a command APDU, from at least an entity, in particular a guest operating system 13ᵢ but also an agent in the hypervisor, configured to send commands CA to a Logical Secure Element, e.g., 14b, in said Secure Element, 14, to be used by an application associated to said Logical Secure Element, e.g., 14b, and to send said command, CA, to said Logical Secure Element, e.g., 14b, in said Secure Element, 14, to be used by the application associated to said Logical Secure Element, e.g., 14b, in said Secure Element, 14.

According to an aspect of the solution here described, the hypervisor 12 comprises a scheduler module, e.g., the Adaptive Logical scheduler module, indicated with 114 in the example, which can be, for instance, integrated within the Logical Secure Element Manager module 113, configured to manage execution, in particular execution in time according to a schedule, of said commands CA, in particular APDUs, coming from such at least an entity, in particular guest operating system 13ᵢ.

The scheduler module 114 is configured to: measure, such as per step 560 in FIG. 4, an execution time, ET, of each command, CA, sent to such application, 14a, in such Secure Element, 14; and update, such as per step 570, a scheduler data structure, in particular a table 114b storing for each different command CA, i.e., each command identified by the same INS code and P1, P2 parameters, an estimated execution time value, AET, estimated on the basis of said measured execution times ET on a plurality NE of executions of said command (CA), in particular calculating the average on a number of executions.

The scheduler module, 114, is configured to: store the commands CA received from said at least an entity, e.g., 13ᵢ) in a queue structure, e.g., 114b; calculate a remaining time before time out, RT, for each command, CA, in said queue, e.g., 114a, as a function, in particular a difference, of a corresponding estimated execution time value, AET, obtained from said data structure, e.g., 114b, and a request time out, T_{OUTi}, value corresponding to said least an entity, e.g., 13ᵢ; and execute first the command CA with the minimum remaining time before time out, indicated with RTM, sending said command CA to the respective the Logical Secure Element, e.g., 14b, of the respective application 14a, i.e., to be received by the application 14a.

As mentioned, the function may be a difference between a corresponding estimated execution time value, AET, obtained from said data structure, e.g., table 114b, and the request time out, T_{OUTi}, value corresponding to said least an entity, e.g., 13ᵢ. The request time out, T_{OUTi} can fixed, i.e., a pre-determined value, or calculated during a setup phase.

Also, the update operation, e.g., 570, comprises also storing in said data structure, e.g., table 114b, the number of executions NE associated to the command CA.

In embodiments, the scheduler 114 may comprise a settable execution time windows size, EWS, setting the size of a mobile window, which takes in account only a last number of measurements of the execution time ET for each command CA.

The structure data, in particular table 114b, may be initialized with a known set of commands CA and an estimate of their execution time (AET), in particular an average.

The scheduling module 114 is configured to perform additionally a prioritization scheme, assigning different priorities to different of said entities, in particular guest operating systems 13ᵢ. Of course, other scheduling strategies may added.

The scheduler 114 may be configured to allocate a table for each entity, in particular for each guest operating system (13ᵢ).

Correspondingly, the solution here described refers to a method for operating a virtual machine architecture comprising a plurality of guest virtual machines managed by a hypervisor, e.g., 12 running on a host, e.g., 11, on which respective instances of a guest operating system, e.g., 13ᵢ, are executed, said architecture, e.g., 10, at least a Secure Element, 14, comprising a plurality of Logical Secure Elements associated to corresponding instances of a guest operating system, e.g., 13ᵢ, by said plurality of virtual machines, e.g., 13ᵢ, comprising receiving at the hypervisor, e.g., 12 one or more commands, e.g., CA, in particular a command APDU, from at least an entity, e.g., 13ᵢ sending commands, e.g., CA to a Logical Secure Element, e.g., 14b, in said Secure Element, 14, to be used by an application associated to said Logical Secure Element, e.g., 14b, and sending said command, CA, to said Logical Secure Element, e.g., 14b, in said Secure Element, 14, to be used by the application associated to said Logical Secure Element, e.g., 14b, in said Secure Element, 14. The method comprises: managing at a scheduler module, e.g., 114, in said hypervisor, e.g., 12, execution of the commands, e.g., CA, in particular APDUs, coming from said at least an entity, e.g., 13ᵢ, by: measuring, e.g., 560 an execution time, e.g., ET of each command, e.g., CA sent to said application, e.g., 14a in said Secure Element, e.g., 14; updating, e.g., 570 an estimated execution time value, e.g., AET, estimated on the basis of said measured execution times, e.g., ET on a plurality, e.g., NE of executions of said command, e.g., CA; storing commands, e.g., CA received from said at least an entity, e.g., 13ᵢ in a queue, e.g., 114b structure, calculating a remaining time before time out, e.g., RT for each command, e.g., CA in said queue, e.g., 114a as a function of a corresponding estimated execution time value, e.g., AET obtained from said data structure, e.g., 114b and a request time out, e.g., T_{OUTi} value corresponding to said least an entity, e.g., 13ᵢ; and executing first the command, e.g., CA APDU with the minimum remaining time before time out, e.g., RTM sending said command, e.g., CA to the Logical Secure Element of the respective associated application, e.g., 14a.

As indicated in FIG. 4, the method more in detail may comprise: checking, e.g., 510, if there is any pending command, e.g., CA in said queue, e.g., 114a; in the affirmative, for each pending command, CA, in said queue, e.g., 114a, (as dictated by control flow blocks 515, 535 in the implementation of FIG. 4) reading, e.g., 520 the average execution time, e.g., AET from the data structure, in particular table, e.g., 114b corresponding to a command, e.g., CA in the queue, e.g., 114a; calculating, e.g., 530 said remaining time, e.g., RT as difference between a corresponding estimated execution times, e.g., AET from said data structure, e.g., 114b and a request time out, e.g., T_{OUTi} value corresponding to said least an entity, e.g., 13ᵢ; selecting, e.g., 540 for execution the command, e.g., CA in the queue, e.g., 114a with the minimum estimated remaining time, e.g., RTM; executing, e.g., 550 the selected command, e.g., CA; measuring, e.g., 560 an execution time ET of the selected command, e.g., CA; and updating, e.g., 570 the estimated execution time, e.g., AET in the data structure, in particular table 114b, and in particular also the number of executions, e.g., NE for the selected command, e.g., CA.

Of course, the method may include all the further operation which the virtual machine architecture is configure to perform, e.g.: the update, 570, comprises also storing in said data structure, e.g., table 114b said number of executions NE and, in particular also parameters P1, P2 associated to the command CA; setting a settable execution time windows size, EWS, setting the size of a mobile window, which takes in account only a number of the last, i.e., most recent, measurements of the execution time, ET, for each command, CA; the request timeout, T_{OUTi}, is a fixed timeout known a priori or a timeout calculated during a setup phase of the scheduler, 114; initializing the structure data, in particular table, 114b, with a known set of commands, CA, and an estimate of their average execution time, AET; performing additionally a prioritization scheme, assigning different priorities to different of said entities, in particular guest operating systems, 13ᵢ; different tables for different applications.

Thus, from the above description the advantages of the solution here described appear clear.

The solution here described advantageously minimize the timeout probability.

Also, this solution is part of the Hypervisor firmware, e.g., the Adaptive Logical scheduler module may be a software module integrated into the Hypervisor 12 firmware, this providing a more comprehensive approach to the scheduling problem.

Also the solution enables a dynamic management of the resources.

Without prejudice to the underlying principles, the details and the embodiments may vary, even significantly, with respect to what has been described by way of example only without departing from the scope of the embodiments.

For instance, while the data structure in the scheduler can be efficiently embodied by a table, another data structure, organized in records and fields, may be used.

Although the solution described uses as estimate of the execution time and average of the execution time over the occurrences of the request, e.g., APDU command, it is underlined that an estimate can be obtained on the basis of the incoming measurements using different functions for the estimate, i.e., other type of average or function finding a mean value, e.g., geometric mean instead of arithmetic mean. In the same way the estimate of the remaining time as a function of the estimated, e.g., average, execution time and the time out value can be not only a simple difference, but another function taking in account the difference between such two values, e.g., a weighted difference, i.e., each of the value is multiplied by a determined weight value.

The entity sending the command CA can be represented also by a software agent operating in the hypervisor 12, as long as it is a software module which sends commands CA to a corresponding application or applet, i.e., a software agent which sends a command CA (and receive the response RA as well) from within the Hypervisor 12, e.g., to update the Secure Element operating system. Such a hypervisor agent may thus send the command CA to any of the Logical Secure Elements in the Secure Element.

The claims are an integral part of the technical teaching provided in respect of the embodiments.

The extent of protection is determined by the annexed claims.

1. A virtual machine architecture, comprising:
a plurality of guest virtual machines managed by a hypervisor running on a host, wherein respective instances of guest operating systems are executed on the plurality of guest virtual machines;
wherein said virtual machine architecture is configured to access at least a Secure Element that includes a plurality of Logical Secure Elements associated to corresponding instances of the guest operating systems;
wherein said hypervisor is configured to receive one or more commands from at least one entity configured to send commands to a Logical Secure Element in said Secure Element to be used by an application associated to said Logical Secure Element, and to send the received one or more commands to said Logical Secure Element in said Secure Element to be used by the application associated to said Logical Secure Element in said Secure Element;
wherein said hypervisor comprises a scheduler module configured to manage execution of said one or more commands received from said at least one entity, wherein said scheduler module is configured to:
measure an execution time of each command sent to said application in said Secure Element;
update a scheduler data structure storing, for each different command, an estimated execution time value, estimated on a basis of the execution time of each command on a plurality of executions of said command;
store commands received from said at least one entity in a queue structure;
calculate a remaining time before time out for each command in said queue structure as a function of a corresponding estimated execution time value obtained from said scheduler data structure and a request time out value corresponding to said at least one entity; and
execute first the command with a minimum remaining time before time out sending said command to the Logical Secure Element of the respective application.

2. The virtual machine architecture according to claim 1, wherein said function is a difference between a corresponding estimated execution time value obtained from said scheduler data structure and a request time out value corresponding to said least one entity.

3. The virtual machine architecture according to claim 1, wherein said estimate is an average of said measured execution time calculated over a number of executions of said command.

4. The virtual machine architecture according to claim 1, wherein said update further comprises storing in said scheduler data structure a table with said number of executions and parameters associated to the command.

5. The virtual machine architecture according to claim 1, wherein said at least one entity comprises one guest operating system among said guest operating systems.

6. The virtual machine architecture according claim 1, wherein said scheduler module further comprises a settable execution time window size setting a size of a mobile window which takes in account only a number of last measurements of the execution time for each command.

7. The virtual machine architecture according to claim 1, wherein said request timeout is one of: a fixed timeout known a priori or a timeout calculated during a setup phase of the scheduler module.

8. The virtual machine architecture according to claim 1, wherein said scheduler data structure provided in a table is initialized with a known set of commands and an estimate of their execution time.

9. The virtual machine architecture according to claim 1, wherein said scheduler module is configured to additionally perform a prioritization scheme which assigns different priorities to different guest operating systems.

10. The virtual machine architecture according to claim 1, wherein said hypervisor comprises a driver of the Secure Element associated to said guest operating system through a respective virtual device and wherein the virtual device is configured to pass commands, and responses between the said guest operating system and the Secure Element, through said scheduler module.

11. The virtual machine architecture according to claim 1, wherein said scheduler module is configured to allocate different tables for different applications.

12. The virtual machine architecture according to claim 1, wherein said architecture is configured to access a set of Logical Secure Elements in said Secure Element, which are accessible from said guest operating systems.

13. A method for operating a virtual machine architecture that includes a plurality of guest virtual machines, which are managed by a hypervisor running on a host, on which respective instances of a guest operating system are executed, said architecture accessing at least a Secure Element comprising a plurality of Logical Secure Elements associated to corresponding instances of the guest operating system by said plurality of virtual machines, the method comprising:
receiving at the hypervisor one or more commands from at least one entity sending commands to a Logical Secure Element in said Secure Element to be used by an application associated to said Logical Secure Element;
sending said command to said Logical Secure Element in said Secure Element to be used by the application associated to said Logical Secure Element in said Secure Element;
managing at a scheduler module in said hypervisor execution of the commands received from said at least one entity by:
measuring an execution time of each command sent to said application in said Secure Element;
updating a scheduler data structure storing an estimated execution time value, estimated on the basis of said measured execution times on a plurality of executions of said command;
storing commands received from said at least one entity in a queue structure;
calculating a remaining time before time out for each command in said queue as a function of a corresponding estimated execution time value obtained from said scheduler data structure and a request time out value corresponding to said least one entity; and
executing first the command with the minimum remaining time before time out sending said command to the Logical Secure Element of the respective associated application.

14. The method of claim 13, further comprising
checking if there is any pending command in said queue;
in the affirmative, for each pending command in said queue, reading an estimated execution time from the scheduler data structure corresponding to a command in the queue;
calculating said remaining time as difference between a corresponding estimated execution times from said scheduler data structure and a request time out value corresponding to said least one entity;
selecting for execution the command in the queue with the minimum estimated remaining time;
executing the selected command;
measuring an execution time of the selected command;
updating the estimated execution time in the scheduler data structure and also the number of executions for the selected command.

15. The method of claim 13, where said function is a difference between a corresponding estimated execution time value obtained from said scheduler data structure and a request time out value corresponding to said least one entity and said estimated execution time value is the average of said measured execution time calculated over a number of executions of said command.
